(19) United States
(12) Patent Application Publication
(10) Pub. No.: US 2012/0190128 A1
(43) Pub. Date: Jul. 26, 2012

(54) MODULAR MICROFLUIDIC SAMPLE PREPARATION SYSTEM AND METHOD OF MIXING AND DELIVERING A SAMPLE FLUID

(75) Inventors: Reza NIKBAKHT, Copenhagen NV (DK); Iben Schildt SØRENSEN, Copenhagen N (DK); Jens MIKKELSEN, Ballerup (DK); Peter WARTHOE, Copenhagen O (DK)

(73) Assignee: ATONOMICS A/S, Copenhagen SV (DK)

(21) Appl. No.: 13/010,968

(22) Filed: Jan. 21, 2011

(51) Int. Cl. G01N 1/28; B01L 99/00

(52) U.S. Cl. 436/180; 422/502; 422/68.1

(57) ABSTRACT

A modular microfluidic sample preparation system (1), wherein the system comprises a first preparation module (2). The first preparation module (2) comprising a first surface (24) and an opposing second surface (25) and being delimited by first lateral faces (7). The first preparation module (2) comprises an outlet (38) arranged at the second surface (25) of the first preparation module (2) and an inlet (4), the inlet (4) and the outlet (38) being connected via a first microfluidic channel system (26). A second preparation module (3) comprises a first surface and an opposing second surface and being delimited by second lateral faces (8). Said second preparation module (3) further comprises an intake (10). The intake (10) being connected to a second microfluidic channel system (50). The first preparation module (2) is connected to the second preparation module (3) so that the second surface (25) faces the first surface of the second preparation module (3) and so that the outlet (38) faces the intake (10).

### TECHNICAL FIELD

The present invention relates to a modular microfluidic sample preparation system where the system comprises:
a first preparation module arranged in a first plane,
   the first preparation module comprising a first surface and an opposing second surface and being delimited by first lateral faces,
   the first preparation module further comprising an outlet arranged at the second surface of the first preparation module and an inlet, the inlet and the outlet being connected via a first microfluidic channel system, and
a second preparation module arranged in a second plane substantially parallel to the first plane,
   the second preparation module comprising a first surface and an opposing second surface and being delimited by second lateral faces,
   the second preparation module further comprising an intake arranged at the first surface of the second preparation module, the intake being connected to a second microfluidic channel system.

Furthermore, the present invention relates to a method of mixing a sample fluid and an additive in a first preparation module and delivering said mixed sample fluid and additive to a second preparation module using a modular microfluidic sample preparation system.

### BACKGROUND ART

Microfluidic systems are used in a number of laboratory automation applications, such as the preparation of fluid samples for further analysis. Such a microfluidic sample preparation system may be formed as a cartridge for insertion into a cooperating slot of an apparatus for performing the actual measurement and analysis of the sample prepared by the microfluidic system.

Furthermore, sample preparation of complex fluids, such as the preparation of blood samples for a specific measurement/analysis, often requires numerous steps. Some of these sample preparation steps may be of a general nature, and are usually performed in substantially the same manner for different types of measurements/analysis, whereas other sample preparation steps are specific to the specific measurement/analysis to be performed.

The numerous processing steps give rise to a complex microfluidic system that requires a large footprint for its implementation on a microfluidic chip. Such a complex microfluidic system is difficult to manufacture, and may lead to substantial problems in production, with low production yields as a consequence. Therefore, the manufacturing of such systems sets high standards for the capabilities of the manufacturing facilities.

In addition to that, different parts of the systems may require different capabilities of the manufacturing system, for example if active fluids need to be filled into reservoirs of a system, these typically need to be handled differently compared to less fragile parts of the system, e.g. common plastic parts. During the manufacturing of the parts for a microfluidic sample preparation system, the most demanding part sets the general standard of the parameters for all the parts of the system. Such parameters could e.g. be the level of cleanness in the production, sensitivity to heat, sensitivity to pressure or similar parameters. However, manufacturing the system by a standard, which is in fact too high for most of the parts, is expensive. Furthermore, the different parts of the system may require different storing facilities, e.g. if the system contains fluids that need storage in a controlled environment, e.g. with respect to moisture or temperature. Storing both sensitive parts and non-sensitive parts in a controlled environment takes up space in storage facilities and is inefficient as storing in a controlled environment is far more expensive than storing in a standard environment.

It is an object of the invention to provide a new and improved modular microfluidic sample preparation system which, at least partially, overcomes the disadvantages of the systems mentioned above.

### DISCLOSURE OF THE INVENTION

This aspect is obtained by a modular microfluidic sample preparation system of the above mentioned type, wherein the first preparation module is connected to the second preparation module so that the second surface of the first preparation module is facing towards the first surface of the second preparation module and so that the outlet of the first preparation module faces the intake of the second preparation module.

Preparation steps performed by the modular microfluidic sample preparation system according to the invention may comprise dosing, mixing, adding additives or reagents, incubation, filtering, temperature stabilisation, presentation of the prepared sample at a measurement port, such as in a sample chamber with an optical window, and the like.

Hereby, the first preparation module and the second preparation module can be manufactured separately and be mutually connected afterwards. The preparation modules may demand a different level of e.g. cleanness in the manufacturing facilities. By separating the cartridge into at least two preparation modules, it is possible to manufacture the preparation modules at different locations, each complying with different production standard requirements. The outlet of the first preparation module is arranged such that a fluid e.g. a blood sample that has been preconditioned in the first module, is delivered from the outlet of the first preparation module and received by the intake of the second preparation module from where it is transported into the microfluidic channel system of the second preparation module.

Furthermore, by splitting the sample preparation system into preparation modules for different steps of the preparation process, the complexity of each of the separately produceable preparation modules is reduced, thereby reducing the complexity of the process for producing the preparation modules. This simplifies the production and thereby improves the production yield for the total sample preparation system.

The modular structure of the sample preparation system also allows for combining different types of first and second preparation modules. For example, the first preparation module may be designed for performing general steps such that the output from the first preparation module is a pre-configured fluid sample that is suited for use as input for different specific sample preparation steps. The specific sample preparation steps for different types of measurements/analyses may be implemented in the second preparation module. Alternatively, first preparation modules for different types of sample pre-configurations may be provided, which are compatible with the same type of second preparation module.

In another embodiment according to the invention, the first preparation module and the second preparation module may comprise connecting means for detachably connecting the first preparation module with the second preparation module. In this way, it is possible to use each of the modules together with other modular sample preparation systems. The first and the second preparation module being detachable, renders it possible to use the preparation modules together with other sample preparation modules or sample systems.

The preparation modules may be provided with releasable connection means, e.g. forming a snap lock connection. This allows for an easy assembly/configuration of the desired sample preparation system at the end user site by choosing and connecting the required types of first and second preparation modules. The above-mentioned easy combination/configuration of different types of preparation modules is thus also available to the end user.

Furthermore, in case of the malfunction of a preparation module, it is possible to exchange a preparation module with another. The connecting means furthermore provide that the preparation modules are correctly positioned in relation to each other. Furthermore, it is possible to store the preparation modules separately and connecting them just before use. In this way, it is possible to store the preparation modules in facilities just suitable for the specific preparation modules, thereby optimizing the storing costs. For example, different preparation modules may have different shelf lives depending on the content of reagents supplied in the module. If active or otherwise time sensitive content is comprised in a module, it is advantageous that such module be kept at a stock number just sufficient to supply the demand within the durability of such content. However, if a first preparation module compared to a second preparation module can be stored for a longer period, the manufacturing costs can be lowered by producing a higher number of less sensitive modules in one batch. Thus, the assembling i.e. connecting of the sensitive and the less sensitive preparation modules just before shipping, or even at the location of the end user may have an influence on the total costs of the modular microfluidic sample preparation system.

In one embodiment according to the invention, the first lateral faces of the first preparation module may comprise connecting means (e.g. a bead or a ridge) for connecting a recessed area of the second lateral faces of the second preparation module (or vice versa). In this way a simple and reliable system of connecting the two preparation modules is provided. The manufacturing of such connecting means can be carried out during a moulding process and is thus cheap to manufacture.

In a further embodiment of the invention, the preparation modules of the system, when connected, forms a cartridge. During use, the end user is faced with just one object to handle. Although the microfluidic sample preparation system is modular, the end user is still faced with just one object to handle.

Preferably, the cartridge comprises all reagents and/or additives to be mixed with the sample during the sample preparation process, thereby ensuring that only the fluid sample to be analysed needs to be handled and presented at the input port of the cartridge. The cartridge provides everything required during the sample preparation process and a measuring port for performing measurements on the prepared sample.

Preferably, such measurements are optical measurements, and the cartridge presents the prepared sample in a sample chamber/channel that is provided with an optical access port/window. The cartridge may be inserted into a cooperating analysis apparatus activating/driving the sample preparation process, e.g. by mechanical, electrical, and/or optical means, by radiation and/or temperature control. The analysing apparatus may further perform measurements on the prepared sample at the above-mentioned measurement port, such as optical or electrical measurements. By configuring the cartridge such as to integrate additive/reagent compartments, it is further achieved that any fluid handling may be confined to filling the cartridge with the sample to be analysed. Any fluid exchange between the cartridge and the analysis apparatus, or any fluid handling by the analysis apparatus may thus be avoided, thereby decreasing the complexity of the analysis apparatus, shrinking the lab-space footprint of the analysis apparatus, and reducing the need for cleaning and maintaining the analysis apparatus to a minimum.

In a further embodiment of the invention, the modular microfluidic sample preparation system may be a modular microfluidic blood sample preparation system.

In yet another embodiment according to the invention, the outlet of the first preparation module may be positioned at a distance from the intake of the second preparation module.

When connected, the first and second preparation modules are aligned such that the outlet of the first preparation module opens towards an intake opening of the second preparation module. The intake of the second preparation module comprises receiving means adapted to receive the fluid from the outlet of the first preparation module and delivery means to deliver the fluid to the microfluidic channel system of the second preparation module.

Typically, the area of the intake opening/receiving means of the intake of the second preparation (the second preparation module intake) is larger than the cross-sectional area of the outlet of the first preparation module (the first preparation module outlet). Providing a distance between the outlet and the surface of the receiving means of the second preparation module intake facilitates the lateral distribution of the fluid sample expelled from the first preparation module outlet over the reception means surface/intake opening of the second preparation module.

Fluid may be transferred from the first module to the second preparation module in the following manner; Fluid is expelled from the first preparation module outlet by a driving force, such as hydrostatic pressure applied in/to the first preparation module. The fluid expelled from the first preparation module outlet is accumulated around the outlet of the first preparation module before the fluid is getting into contact with the surface of the intake of the second preparation module. Upon contact with the surface of the second preparation module intake, the fluid may be distributed over the surface of the intake receiving means. Delivery means are provided in the intake for transferring the received fluid sample to the microfluidic channel system of the second preparation module. One advantage of the fluid transfer from the first preparation module to the second preparation module according to the present modular sample preparation system is that it does not require a sealed fluid interconnect between the microfluidic channel systems of the first and second preparation modules, or any critical pressure/fluid tight seal when attaching the first module to the second preparation module. Thereby it is achieved that the sample preparation system may easily be assembled from prefabricated first and second preparation modules at the end user site without requiring special production skills or dedicated equipment.

The receiving means of the second preparation module intake may be a sheet of woven/non-woven fibrous material adapted to at least partially absorb/imbibe/soak up the fluid sample. The sheet is arranged in the intake opening of the second preparation module and facing towards the outlet opening when the two preparation modules are connected. The sheet is dimensioned such that the fluid sample, when soaked up by the fibrous material, may reach an intake capillary connecting the receiving means to the microfluidic channel system of the second preparation module. The intake capillary may be arranged at one of the edges of the sheet of fibrous material. By capillary action, the intake capillary may retrieve the imbibed fluid sample—or in the case of a multiple component fluid at least one of the components of the multiple component fluid—and deliver it to the microfluidic channels system of the second preparation module for further processing.

The distance furthermore provides sufficient space if e.g. the intake of the second preparation module comprises swelling material that expands when getting into contact with a fluid. In this way, it is possible to use different materials at the intake of the second preparation module.

In an advantageous embodiment according to the invention, the distance between the outlet of the first preparation module to the intake of the second preparation module may be 0.05 mm-1 mm or 0.1 mm-0.9 mm or 0.15 mm-0.8 mm. In this way, a free space is created wherein fluid from the outlet of the first preparation module may bulge out, still being in contact with the outlet, before said fluid is delivered to the intake of the second preparation module. Furthermore, sufficient space for expansion is provided. If the intake of the second preparation module is e.g. a filter having a thickness of approximately 0.32 mm which expands due to swelling upon wetting, such filter may expand approximately 0.15 mm.

In another embodiment according to the invention, the intake of the second preparation module may comprise a blood separation filter. In this way, it is achieved that the intake of the second preparation module prepares the sample, e.g. blood, for the preparation of the sample following in the second preparation module. Thus, the intake of the second preparation module functions as a first step in the preparation carried out in the second preparation module.

Blood is a complex multiple component fluid. The separation of a multiple component fluid into different components may be performed in the intake of the second preparation module by providing receiving means and/or delivery means that are configured to preferably transport one or more desired components as compared to the remaining components present in the fluid sample received from the first preparation module. In particular, the blood filter may be configured to retain white and/or red blood cells while blood plasma is selectively transferred to the microfluidic channel system of the second preparation module.

The selective transport of the blood plasma in the filter may be provided by the capillary effect of the filter, preferably imbibing blood plasma while blood cells are retained by the crosslinked fibres of the filter material. An excess amount of mixed sample fluid, i.e. a blood sample pre-configured with the additive(s) of the first preparation module is provided to the intake of the second preparation module and on the filter, thereby saturating the filter material such that blood plasma reaches the intake capillary connected to the edge of the filter.

As mentioned above, a distance may be provided between the outlet of the first preparation module and the surface of the blood filter in the intake of the second preparation module. The distance allows for delivering the mixed fluid sample onto the blood filter without applying substantial pressure on the filter, thereby avoiding that blood cells are pressed through the filter into the second microfluidic channel system. The filter is dimensioned such that saturation of the filter material with blood plasma may be maintained with the amount of mixed sample fluid delivered to the intake of the second preparation module. Saturation should be maintained as long as needed to retrieve the desired amount of blood plasma into the second preparation module.

The capillary drag of the intake capillary in contact with the saturated filter material drags the fluid into the microfluidic channel system of the second preparation module. A capillary stop that may be provided in the second microfluidic channel system allows for limiting/controlling the volume of sample fluid, here blood plasma, transferred from the intake into the second module.

The blood filter may form the receiving means of the intake, wherein the blood filter is a sheet of filter web with a receiving portion arranged in the intake opening such that the receiving portion under operation faces the outlet opening. Typically, a transverse dimension of the receiving portion exceeds the corresponding transverse dimension of the outlet of the first preparation module. Advantageously, the filter web is therefore arranged at a distance from the outer edge of the outlet opening so as to improve the distribution of fluid over the receiving portion. Furthermore, the sheet of filter web may shaped so as to form a delivery tab, said delivery tab extending outwardly from the receiving portion and being connected to the intake capillary so as to establish a fluid communication between the filter web and the intake capillary.

According to one embodiment, the geometry of the blood filter may have a tapering outline, the wide portion of the tapering outline providing the receiving portion and the pointed portion forming the delivery tab. In this way, it is achieved that the blood filter is directing a fluid contained in the filter in a desired direction, e.g. towards the tapering part. In another embodiment, the filter may exhibit an efficiency of 5-50% or 10-25% output of plasma. The filter may e.g. have a thickness of 0.2 mm to 0.5 mm. Due to capillary drag in the filter, the filter may be wetted by the dispersion of fluid.

In yet another embodiment according to the invention, the outlet of the first preparation module may have a substantially circular cross section. In this way, the sample fluid delivered from the outlet of the first preparation module is equally distributed from the outlet when delivered from the outlet to the intake of the second preparation module. Due to the surface tension of the fluid, the bulge of fluid around the outlet of the first preparation module will be equally distributed around the outlet. The diameter of the outlet may be 0.5 mm-2 mm or 0.75 mm-1.75 mm or 1 mm-1.5 mm.

According to another embodiment of the invention, the outlet of the first preparation module may have a substantially oval cross section. In this way, it is achieved that the sample fluid delivered from the outlet of the first preparation module is delivered to the intake of the second preparation module so as to focus the flow in a certain direction.

In an additional embodiment according to the invention, the first preparation module may comprise a passive microfluidic mixing section in fluid communication with the first microfluidic channel system. In this way, it is achieved that fluids and/or additives supplied to the first preparation module can be mixed with the fluid provided through the inlet of the first preparation module.

In one embodiment according to the invention, the first preparation module may comprise an additive reservoir in fluid communication with the mixing section. In this way, it is possible for the first preparation module to comprise an additive to be added to the sample fluid. The additive reservoir being in fluid communication with the mixing section allows for the additive to be brought into the mixing section, e.g. by letting the sample fluid flow into the additive reservoir, thereby flushing the content of the additive reservoir out, or by forcing the content of the additive reservoir into the mixing section. Once the additive is brought into contact and mixed with the sample fluid, the mixture may require incubation in order to produce an appropriately mixed sample fluid that may be delivered to the second preparation module. For example, the additive may be a reagent comprising a marker, and an appropriate binding of the marker molecules to the target molecules may require such incubation during a given incubation time. Incubation may require temperature stabilisation. Required incubation times depend on the additive in question. For example, when analysing full blood as a sample fluid, the marker additive may be HRP requiring an incubation time in the order of a few minutes. Alternatively, the additive reservoir may comprise components suitable for providing molecular analysis of the sample by e.g. nucleic acid amplification. Such reagents may comprise e.g. nucleic acid polymerases, helicases, primers and/or probes. In one embodiment reagents suitable for analysing sample material through Polymerase Chain Reaction (PCR) are provided through the additive reservoir. In a more preferred embodiment, reagents suitable for analysing sample material through isothermal amplification are used. Such amplification techniques comprise e.g. Helicase Dependant Amplification (biohelix), Recombinase Polymerase Amplification (TwistDx), Nucleic acid sequence-based amplification (NASBA) (Mérieux), Stand displacement amplification (SDA; Becton Dickinson), Transcription mediated amplification (TMA; Gen-Probe), and Loop-mediated isothermal amplification (LAMP; Eiken).

In another embodiment according to the invention, the first preparation module may comprise an inlet reservoir in fluid communication with the inlet and the first microfluidic channel system of the first preparation module. In this way, it is possible to accumulate a sample fluid in the first preparation module.

In yet another embodiment according to the invention, the first preparation module may comprise a capillary stop delimiting the inlet reservoir from the mixing section. In this way it is achieved that the inlet reservoir of the first preparation module does not deliver its contents to the following mixing section unless a driving force, such as hydrostatic pressure, is applied forcing the content past the capillary stop. Thus, it is possible for the end user to fill sample fluid into the inlet reservoir without the sample fluid flowing into the mixing section. The inlet reservoir may thus be used for filling the sample preparation system with a pre-defined dosing volume of fluid. The pre-defined dosing volume may be determined by the total volume of the inlet reservoir. The total volume of the inlet reservoir may be less than 200 μl, alternatively less than 100 μl, and preferably about 50 μl.

Additionally according to the invention, the additive reservoir may comprise a plunger. In this way, it is achieved that the plunger seals the additive reservoir.

In another embodiment according to the invention, the plunger may be arranged such that the plunger can force the content of the additive reservoir into the mixing section. When forcing the plunger into the additive reservoir, the plunger will cause the content to be forced out of the additive reservoir. The plunger may cause a pressure to be built up in the additive reservoir. A wall, e.g. provided by a film or a foil, of the additive reservoir may, upon the build-up of a certain pressure, e.g. provided by pressing the plunger into the additive reservoir, allow the content of the additive reservoir to be delivered to the mixing section of the first preparation module.

In yet another embodiment according to the invention, the first preparation module may comprise closing means for shutting off the inlet of the first preparation module. In this way it is achieved that the sample fluid is kept in the first reservoir of the first module until a pumping pressure is applied. Thereby, the risk of contaminating other samples or operators is minimised. Furthermore, it is achieved that it is possible to let air, pass the closed inlet, e.g. for forcing the fluid around in the first preparation module, without the risk of air escaping through the inlet. In a further embodiment, the closing means may be a hinged lid. In this way, the closing means is kept near to the place of use and the risk of mislplacing the means is minimised. In another embodiment, the closing means may be an adhering foil or film. In yet another embodiment, the closing means may comprise a projection to be inserted in the inlet, thereby providing an air tight closing.

In a particular embodiment according to the invention, the first preparation module may comprise a transparent channel (visible to the end user). In this way, it is possible for the end user to easily determine, whether fluid enters the system, i.e. enters a part of the first microfluidic channel system.

In a further embodiment the transparent channel may be the inlet reservoir of the first preparation module. In this way, it is achieved that the user easily can determine whether the sample is sufficient in order to carry out an analysis of the sample fluid.

In an embodiment according to the invention at least one of the preparation modules may comprise identification means. In this way it is possible to adjust the machine analyzing the sample to the specific test to be performed. In a further embodiment according to the invention, the identification means may be a bar code, a chip or a RFID tag. In this way, the identification can carry a larger amount of information to be set in relation to the analysis to be performed, e.g. age of the preparation modules, type of content in reservoir(s) or batch number of content in reservoir(s).

Furthermore, in an embodiment according to the invention, the first preparation module may further comprise a pumping means, thereby ensuring that the fluid situated in the inlet reservoir of the first preparation module i.e. stopped by a capillary stop can be forced pass said capillary stop into the mixing section of the first preparation module. The pumping means may e.g. be an air filled bladder, a pump or be provided by a flexible membrane or foil covering an air filled reservoir or cavity of the first preparation module.

In one embodiment of the invention a capillary stop may delimit the inlet reservoir and the pumping means, thereby ensuring that the sample fluid does not enter the pumping means.

Furthermore, the invention relates to the use of a modular microfluidic sample preparation system according to any of above-mentioned embodiments for preparation of a blood sample. The sample prepared by using the microfluidic sample preparation system may subsequently be analysed in a blood analysing apparatus. To that purpose, the modular microfluidic sample preparation system may be inserted as a cartridge into a cooperating slot of such blood analysing apparatus. The blood analysing apparatus may further interact with the modular microfluidic sample preparation system so as to activate/drive the preparation process and analyse the sample. The interaction between the sample preparation system and the analysing apparatus may be e.g. mechanically, electrically, by radiation, heat and/or optically.

Furthermore, the invention relates to the use of a modular microfluidic sample preparation system in a blood analysing apparatus. The use of such microfluidic sample preparation system in a blood analysing apparatus provides that the end user only needs to fill-in a sample and the analysing apparatus will then perform the rest in order to carry out the analysis. The volume of the fluid provided to the modular microfluidic preparation system through the inlet port may be less than 100 μl.

Furthermore, the invention relates to a blood analysing apparatus using a modular microfluidic sample preparation system.

In another embodiment of a blood analysing apparatus according to the invention, the pumping means of a first preparation module may be activated by the blood analysing apparatus. In this way the specific time for performing the analysis is controlled by the analysing machine because the sample fluid is kept in the inlet reservoir, i.e. in a controlled non-damaging environment for the sample fluid, until the pumping means is activated.

Furthermore, the invention relates to a method of mixing a sample fluid and an additive in a first preparation module and delivering said mixed sample fluid and additive to a second preparation module using a modular microfluidic sample preparation system, the method comprising the steps of:
connecting a first preparation module comprising a first microfluidic channel system to a second preparation module,
supplying a sample fluid to an inlet reservoir through an inlet of the first preparation module,
closing the inlet of the first preparation module, e.g. by a lid,
forcing the sample fluid from the inlet reservoir into a mixing section of the first preparation module by use of air pressure,
supplying an additive from an additive reservoir into the mixing section of the first preparation module, thereby creating a mixed sample fluid,
mixing the additive and the sample fluid by altering the pressure applied from the air to the fluid in the mixing section,
optionally, incubating the sample fluid mixed with the additive during an incubation time,
providing a hydrostatic pressure to the mixed sample fluid, said hydrostatic pressure provided in the first preparation module by the pumping means thereby forcing the sample fluid mixed with the additive, a mixed sample fluid, through the outlet of the first preparation module to an intake of the second preparation module, and
at least partially transferring the mixed sample fluid from the intake to the second microfluidic channel system comprised in the second preparation module by means of capillary forces. In this way, it is achieved that the control of the mixing process and the delivery from the first preparation module to the second preparation module is carried out only by means of the applied pressure from the pumping means of the first preparation module in combination with the automatic/passive intake means of the second preparation module. The build-up of the modular microfluidic sample preparation system provides that a minimum of action from external means is necessary in order to carry out the preparation. Furthermore, the module build-up is possible due to the automated functionality of the delivery from the one preparation module to the other.

According to another method of preparing a blood sample using a modular microfluidic sample preparation system for analysing in a blood analysing apparatus, the method may comprise the steps of:
providing a first preparation module and a second preparation module assembled in such way that the outlet of the first preparation module is positioned at a distance from the intake of the second preparation module, and
supplying a sample fluid to be analysed in the inlet of the first preparation module such that the sample fluid is contained in an inlet reservoir,
closing the inlet of the first preparation module by a closing means,
inserting a microfluidic sample preparation system comprising the first preparation module and the second preparation module in an analysing apparatus,
applying a pressure in the first microfluidic channel system of the first preparation module by activating a pumping means in order to force the sample fluid in the mixing section,
releasing an additive of the additive reservoir into the mixing section of the first preparation module by means of the analysing apparatus,
altering the pressure in the mixing section such that the sample fluid is mixed with the additive in order to produce a mixed sample fluid,
optionally, incubating the sample fluid mixed with the additive during an incubation time,
delivering the mixed sample fluid from the outlet of the first preparation module to the intake of the second preparation module by dragging the mixed sample fluid into the second microfluidic preparation module using a capillary effect of the channels of the second microfluidic preparation system,
performing the sample preparation specified by the second module, and
analysing the blood sample prepared by modular microfluidic sample preparation system using the blood analysing apparatus.

### BRIEF DESCRIPTION OF THE DRAWING

FIG. 1 shows an embodiment of a modular microfluidic sample preparation system according to the invention,

FIG. 2A shows an exploded view of an embodiment of a first preparation module of a modular microfluidic sample preparation system,

FIG. 2B shows an embodiment of a modular microfluidic sample preparation system according to the invention,

FIG. 3A shows a an embodiment of a the modular microfluidic sample preparation system according to the invention

FIG. 3B shows a cross sectional view of the first and second preparation module when connected to each other, and

FIG. 4 shows schematically a blood filter for use in the intake of one embodiment of the second preparation module.

### DETAILED DESCRIPTION OF THE INVENTION

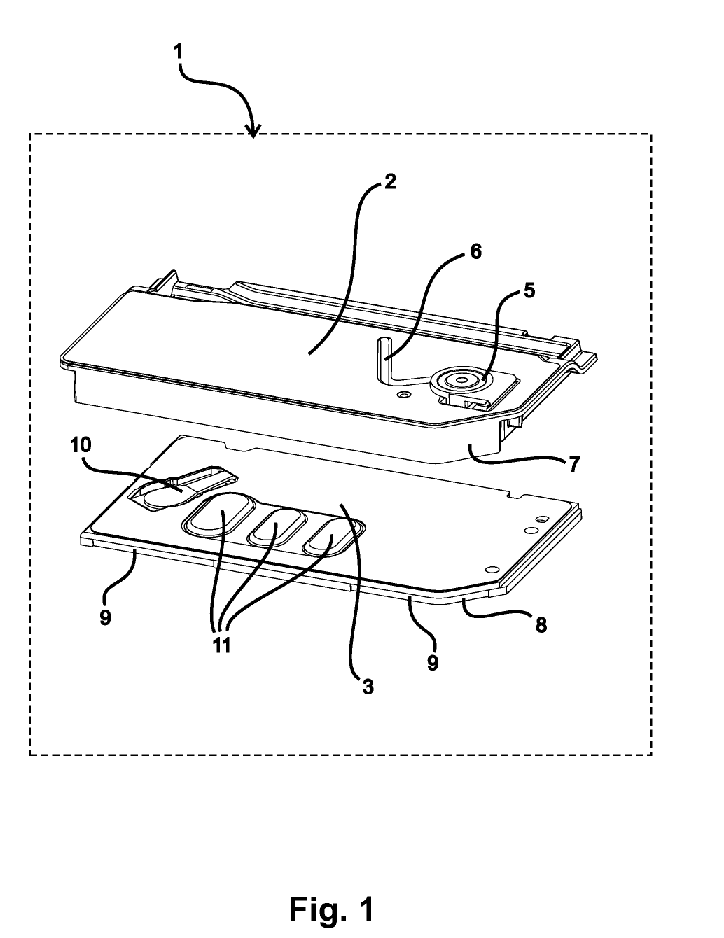

FIG. 1 illustrates a modular microfluidic sample preparation system 1 comprising a first preparation module 2 and a second preparation module 3. The first preparation module 2 comprises an inlet 4 (not visible) closed by a closing means 5. An inlet reservoir 6 is visible for the end user. In this embodiment, the inlet reservoir 6 is a transparent channel of the first preparation module 2 (in the following both the inlet reservoir and the channel are indicated with the number 6). First lateral faces 7 (only partly visible) are arranged to connect the first preparation module 2 to the second preparation module 3. The first lateral faces 7 are arranged so as to connect with the second lateral faces 8 of the second preparation module 3. In the shown embodiment the second lateral faces 8 of the second preparation module comprises a recessed area 9 for receiving connecting means (not visible) of the first preparation module 2. The second preparation module 3 comprises an intake 10 for receiving a fluid delivered from the first preparation module 2. The second preparation module further comprises blisters 11 for containing fluids to be used in the preparation process of the second preparation module 3. When the first preparation module 2 is assembled with and connected to the second preparation module 3, a combined assembly is formed, typically named a cartridge.

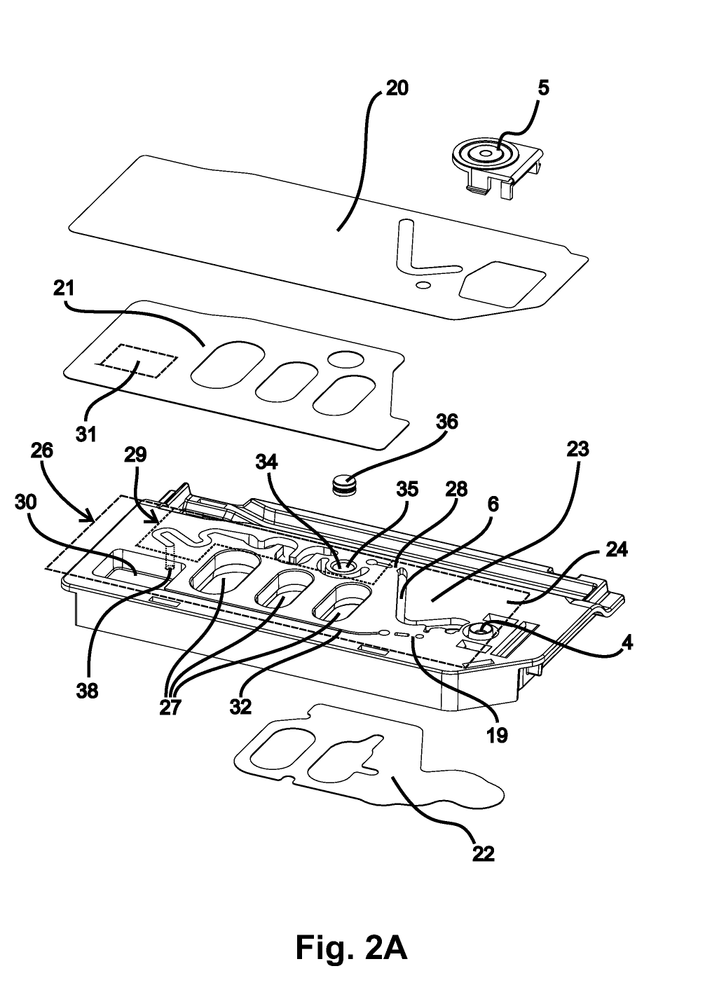

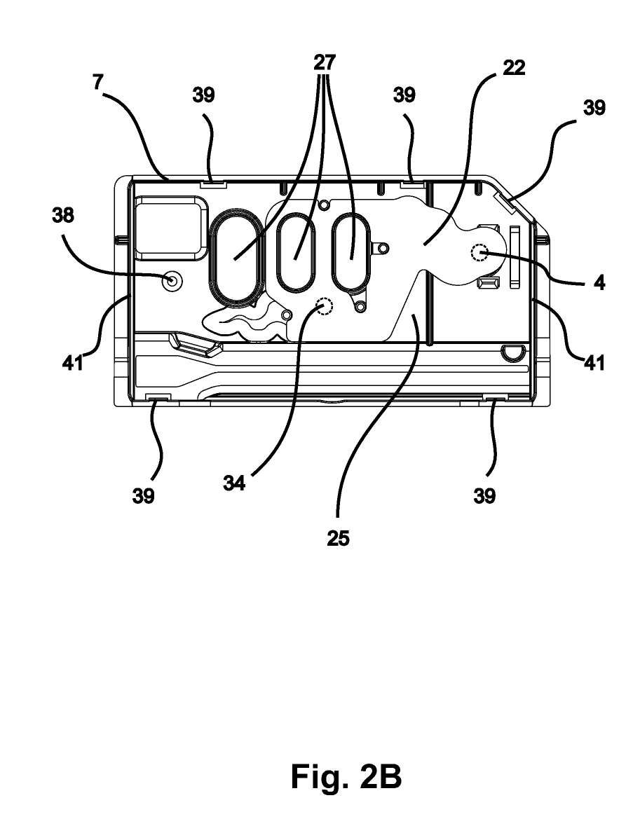

FIG. 2A illustrates an embodiment of the first preparation module 2 in an exploded view. In this embodiment, the first preparation module 2 comprises closing means 5, a first film 20, a second film 21 and a third film 22 attached to an inlet plate 23. The inlet plate having a first surface 24 and a second surface 25 (not visible). The films 20, 21, 22 provide delimiting walls to a first microfluidic channel system 26 of the first preparation module 2. The extend of the first microfluidic channel system 26 is indicated by dotted lines. For illustrative purposes, and due to the fact that the parts of the channel walls in fact are created by both the films 20, 21, 22 and the inlet plate 23, the channels are merely shown as open recesses or indents in the inlet plate 23. Using films 20, 21, 22 for providing delimiting walls to the microfluidic system, the process of manufacturing is made easier. The first preparation module 2 could e.g. be produced by an injection moulding process. The first microfluidic channel system 26 comprises an inlet 4 arranged in fluid communication with the inlet reservoir 6. The through-going apertures 27 provide access to the blisters 11 of the second preparation module 3 (not shown). A capillary stop 28 provides delimitation between the inlet reservoir 6 and a mixing section 29 of the microfluidic channel system 26. A recessed area of the inlet plate 23 provides a pumping means cavity 30 for pumping means 31 (not visible). In this embodiment, the pumping means cavity 30 and the second film 21 together form a pumping means 31. In this way, the pumping means cavity 30 is an air reservoir. Pressure from the pumping means 31 is led through a pressure channel 32. When a sample fluid 33 (not shown in this figure) is lead into the inlet 4, the sample fluid 33 is stored in the inlet reservoir 6. In practice, the size for the inlet reservoir may be less than 200 μl, alternatively less than 100 μl and preferably about 50 μl. The sample fluid 33 is dragged by capillary forces and the inlet reservoir 6 is filled. The sample fluid 33 is stopped by a capillary stop 28 in order to be able to control when the sample fluid 33 should be forced into the mixing section 29. In this way, it is achieved that the timeline of performing the desired steps in the preparation modules is controlled by different activation means and does not necessarily take place instantly when the sample fluid is filled into the inlet. The sample fluid 33 is forced into the mixing section 29 by a pressure applied from the pumping means 31 through the pressure channel 32, passing the inlet 4 that has been closed by the closing means 5. The pumping means is e.g. activated by an analysing apparatus simply by pressing the second film 21 e.g. a flexible membrane, whereby an air pressure is generated to be led through the pressure channel 32. A second capillary stop 19 ensures that sample fluid does not enter the pressure channel 32. The pressure from the pumping means 31 then pushes the sample fluid 33 past the capillary stop 28 into the mixing section. The mixing section comprises an additive reservoir 34. The additive reservoir 34 is provided by a through hole 35 in the inlet plate 23 extending from the first surface 24 to the second surface 25, where the through hole 35 on the second surface 25 (not visible) is closed by the third film 22. A plunger 36 arranged in the through hole 35 closes the through hole on the first surface 24. In this way, a reservoir for containing an additive, e.g. a HRP tracer or similar, is created. Upon applying a force on the plunger 36, the plunger is forced towards the second surface 25 and the content of the additive reservoir 34 is forced against the third film 22 covering the through hole 35 on the second surface 25. The third film 22 is arranged such that when a certain pressure is applied to the third film 22 covering the through hole 35, the third film 22 will loosen from the second surface 25 (not visible) of the inlet plate 23, whereby the content of the additive reservoir 34 is forced into the mixing system 29. Thereby and by manipulating the pressure from the pumping means 31, the sample fluid 33 and the content of the additive reservoir 34 is pushed back and forth in the mixing section, whereby they are mixed creating a mixed sample fluid 37 (not shown). The manipulation of the pressure from the pumping means may be carried out by a blood analysing machine. When mixing is complete, the pressure from the pumping means 31 pushes the mixed sample fluid 37 towards the outlet 38 of the first preparation module 2. The final section of the microfluidic channels system 29 towards the outlet 38 is indicated by dotted lines due to the fact that the outlet 38 is situated on the second surface 25 of the first preparation module 2.

FIG. 2B illustrates the first preparation module 2 of FIG. 2A seen facing the second surface 25. The third film 22 is partly covering the second surface 25. The position of the inlet 4 is indicated by a dotted circle. Likewise, the position of the additive reservoir 34 is indicated by a dotted circle. The sample fluid 33 (not shown) enters the first preparation module through the inlet 4 placed on the first surface and the mixed sample fluid (not shown) leaves the first preparation module 2 through the outlet 38 placed on the second surface 25. The outlet 38, in this embodiment having a circular cross section, may have an internal diameter of approximately 1.3 mm. The first lateral faces 7 comprises connecting means 39 arranged to engage the second lateral faces 8 (not shown) of the second preparation module 3 (not shown. The first lateral faces 7 is to be understood as the faces delimiting the first surface 24 and the second surface 25 and thus defining the outer perimeter of the first preparation module 2. Furthermore, the first lateral faces 7 may comprise walls 41 projecting from the second surface 25. The projecting walls 41 serve to position the first preparation module 2 correctly in relation to the second preparation module 3.

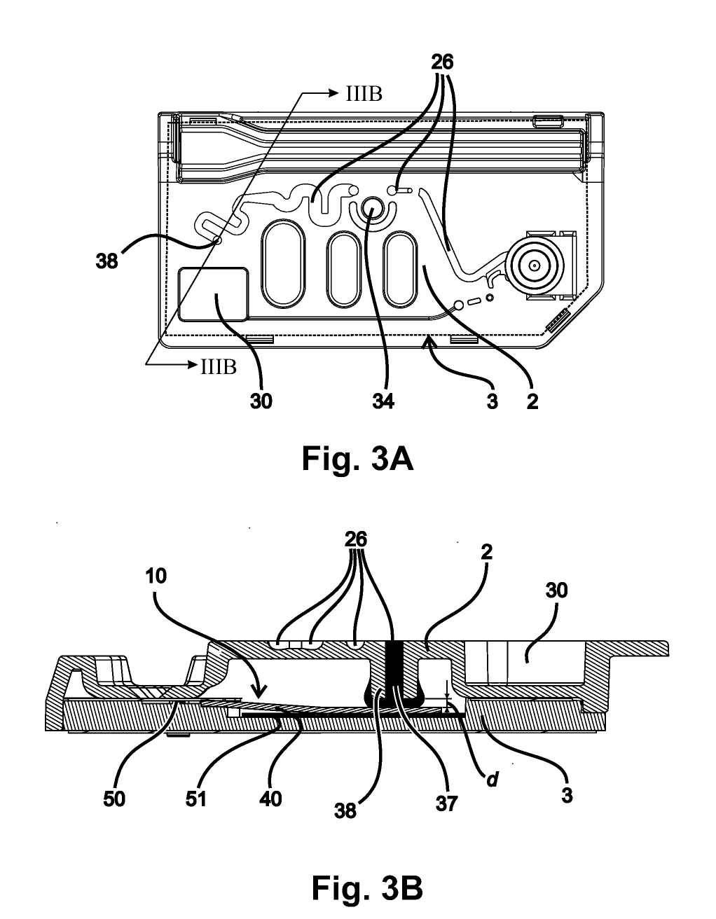

FIG. 3A primarily illustrates according to which cut the cross sectional view of FIG. 3B is obtained. The first preparation module 2 is connected to the second preparation module 3 (the second preparation module only indicated by a dotted line). The details of the FIG. 3A is explained in further details in FIG. 2A.

FIG. 3B illustrates the delivery of a mixed sample fluid 37 i.e. blood being delivered from the outlet 38 to the intake 10 of the second preparation module 3. In this embodiment, the intake 10 comprises a blood filter 40. The blood filter 40 may have a thickness of approximately 0.32 mm. The pressure from the pumping means 31 at the pumping cavity 30 and thus the mixed sample fluid 37 is delivered to the intake 10 as a hydrostatic pressure. By a combination of the hydrostatic pressure applied on the mixed sample fluid 37 and a capillary effect of the intake 10, i.e. the blood filter 40, the mixed sample fluid 37 is dragged towards the second microfluidic channel system 50 of the second preparation module 3. During the process of dragging the mixed sample fluid 37 from the outlet 38 to the second microfluidic channels system 50, the red and white blood cells are filtered from the blood plasma and only blood plasma is delivered to the second microfluidic channels system 50 of the second preparation module 3. A backing material 51 ensures that the surface to which the filter is fastened to the second preparation module 3 exhibits known conditions. Due to the distance d between the outlet 38 and the blood filter 40, the microfluidic channel system 26 of the first preparation module 2 and the microfluidic channel system 50 of the second preparation module 3 are not in direct fluid communication. The mixed sample fluid 37 is placed on top of the blood filter 40. The mixed sample fluid 37 infuses the blood filter 40. When the blood filter 40 is filled with the mixed sample fluid 37, the filtered fluid is forced into contact with the second microfluidic channel system 50 by the capillary drag of the blood filter. When the filtered blood, i.e. blood plasma, is brought in contact with the second microfluidic channel system 50, capillary forces drag the blood plasma into the second microfluidic channel system 50. Due to the controlling of the hydrostatic pressure on the mixed sample fluid 37, i.e. providing a constant supply of mixed sample fluid 37 to the blood filter 40 and the characteristics of the blood filter 40, it is possible to deliver a filtered mixed sample fluid 37 from the outlet 38 of the first microfluidic channel system 26 as a filtered mixed sample fluid to the second microfluidic channel system 50, without the channels of the two systems 26, 50 being in direct fluid communication. The distance d between the outlet 38 and the blood filter 40 provides that the mixed sample fluid 37 is delivered on top of the blood filter 40 as opposed to being forced into the blood filter 40. A blood filter 40 having a thickness of e.g. 0.32 mm may increase approximately 0.15 mm in height when a fluid is infused. The delivery from the first microfluidic system 26 to the intake 10 creates of a fluid column consisting of the mixed sample fluid 37 which keeps supplying the blood filter 40 with fluid. When the supply of mixed sample fluid 37 is continued at such rate that the fluid column does not break apart, the capillary drag of the microfluidic channel system 50 and the capillary properties of the blood filter 40 will continue to supply filtered fluid to the second microfluidic channel system 50. The blood filter 40 is adapted such that approximately 4 μl of blood plasma is delivered to the second microfluidic channel system 50 before the filtering effect of the blood filter is decreased, i.e. that e.g. undesired red blood cells will start to be dragged into the second microfluidic channel system 50. A quantity of 4 μl is sufficient to carry out the sample preparation specified in the second preparation module 3. When stopping the hydrostatic pressure applied from the first preparation module 2 the supply of filtered mixed sample fluid to the second microfluidic channel system 50 will stop. The blood filter may have an efficiency of 15-20%.

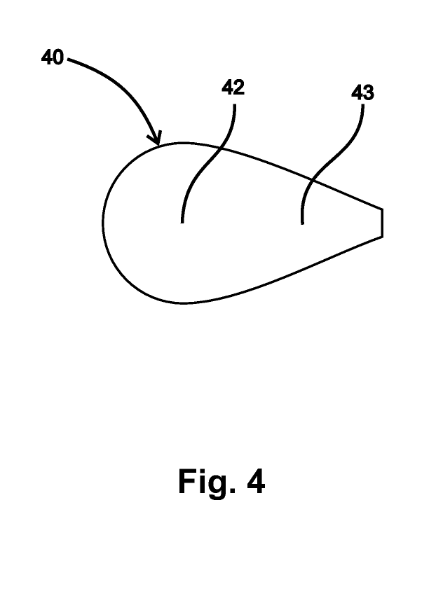

FIG. 4 shows schematically the outline shape of a blood filter 40 for use as the receiving means of the intake of one embodiment of the second preparation module. The blood filter 40 has a tapered outline with a receiving portion 42 in the wide end and a delivery tab 43 extending outwardly from the receiving portion 42 to the narrow end of the tapered outline. When installed in the intake 10 of the second module 3, the receiving portion 42 of the blood filter 40 is arranged in the intake opening, and the delivery tab 43, is connected to the intake capillary connecting the blood filter 40 to the second microfluidic channel system 50.

The invention has been described with reference to preferred embodiments. Many modifications are conceivable without thereby deviating from the scope of the invention. Modifications and variations obvious to those skilled in the art are considered to fall within the scope of the present invention.

1. A modular microfluidic sample preparation system (1), wherein the system comprises:
a first preparation module (2) arranged in a first plane,
the first preparation module (2) comprising a first surface (24) and an opposing second surface (25) and being delimited by first lateral faces (7),
the first preparation module (2) further comprising an outlet (38) arranged at the second surface (25) of the first preparation module (2) and an inlet (4), the inlet (4) and the outlet (38) being connected via a first microfluidic channel system (26),
a second preparation module (3) arranged in a second plane substantially parallel to the first plane,
the second preparation module (3) comprising a first surface and an opposing second surface and being delimited by second lateral faces (8),
the second preparation module (3) further comprising an intake (10) arranged at the first surface of the second preparation module (3), the intake (10) being connected to a second microfluidic channel system (50), and wherein,
the first preparation module (2) is connected to the second preparation module (3) so that the second surface (25) of the first preparation module (2) is facing towards the first surface of the second preparation module (3) and so that the outlet (38) of the first preparation module (2) faces the intake (10) of the second preparation module (2).

2. A modular microfluidic sample preparation system (1) according to claim 1, wherein the first preparation module (2) and the second preparation module (3) comprises connecting means (9, 39) for detachably connecting the first preparation module (2) with the second preparation module (3).

3. A modular microfluidic sample preparation system (1) according to claim 1, wherein the outlet (38) of the first preparation module (2) is positioned at a distance (d) from the intake (10) of the second preparation module (3).

4. A modular microfluidic sample preparation system (1) according to claim 3, wherein the distance (d) between outlet (38) of the first preparation module (2) to the intake (10) of the second preparation module (3) is 0.05 mm-1 mm or 0.1 mm-0.9 mm or 0.15 mm-0.8 mm.

5. A modular microfluidic sample preparation system (1) according to claim 1, wherein the intake (10) of the second preparation module (3) comprises a blood separation filter (40).

6. A modular microfluidic sample preparation system (1) according to claim 1, wherein the first preparation module (2) comprises a passive microfluidic mixing section (29) in fluid communication with the first microfluidic channel system (26).

7. A modular microfluidic sample preparation system (1) according to claim 6, wherein the first preparation module (2) comprises an additive reservoir (34) in fluid communication with the mixing section (29).

8. A modular microfluidic sample preparation system (1) according to claim 1, wherein the first preparation module (2) comprises an inlet reservoir (6) in fluid communication with the inlet (4) and the first microfluidic channel system (26) of the first preparation module (2).

9. A modular microfluidic sample preparation system (1) according to claim 1, wherein the first preparation module (2) comprises a transparent channel (6).

10. A modular microfluidic sample preparation system (1) according to claim 1, wherein the first preparation module (2) further comprises a pumping means (31).

11. (canceled)

12. Blood analysing apparatus using a modular microfluidic sample preparation system (1) according to claim 1.

13. Blood analysing apparatus according claim 12, wherein the pumping means (31) of the first preparation module (2) is activated by the blood analysing apparatus.

14. Method of mixing a sample fluid (33) and an additive in a first preparation module (2) and delivering said mixed sample fluid (37) to a second preparation module (3) using a modular microfluidic sample preparation system (1), the method comprising the steps:
connecting a first preparation module (2) comprising a first microfluidic channel system (26) to a second preparation module (3) the second preparation module (3) comprising a second microfluidic channel system (50),
supplying a sample fluid (33) to an inlet reservoir (6) through an inlet (4) of the first preparation module (2),
closing the inlet (4) of the first preparation module (2) by closing means (5),
forcing the sample fluid (33) from the inlet reservoir into a mixing section (26) of the first preparation module (2) by use of air pressure,
supplying an additive from an additive reservoir (34) into the mixing section (26) of the first preparation module (2),
mixing the additive and the sample fluid (33) by altering the pressure applied by the air to the fluid in the mixing section (26) thereby creating a mixed sample fluid (37),
providing a hydrostatic pressure to the mixed sample fluid (37), said hydrostatic pressure provided in the first preparation module (2) by the pumping means (31) thereby forcing the mixed sample fluid (37), through the outlet (38) of the first preparation module (2) to an intake (10) of the second preparation module (3), and
at least partially transferring the mixed sample fluid (37) from the intake to the second microfluidic channel system (50) comprised in the second preparation module (3) by means of capillary forces.

15. Method of preparing a blood sample using a modular microfluidic sample preparation system (1) according to claim 14 for analysing the blood sample in a blood analysing apparatus, the method comprising the steps of:
providing a first preparation module (2) and a second preparation module (3) assembled in such way that the outlet (38) of the first preparation module (2) is positioned at a distance (d) from the intake (10) of the second preparation module (3), and
supplying a sample fluid (33) to be analysed in the inlet (4) of the first preparation module (2) such that the sample fluid (33) is contained in an inlet reservoir (6),
closing the inlet (4) of the first preparation module (2) by a closing means (5),
inserting a microfluidic sample preparation system (1) comprising the first preparation module (2) and the second preparation module (3) in an analysing apparatus,
applying a pressure in the first microfluidic channel system (26) of the first preparation module (2) by activating a pumping means (31) in order to force the sample fluid (33) in the mixing section (26),
by means of the analysing apparatus, releasing an additive of the additive reservoir (34) into the mixing section (26) of the first preparation module (2),
altering the pressure in the mixing section (26) such that the sample fluid (33) is mixed with the additive in order to produce a mixed sample fluid (37),
delivering the mixed sample fluid (37) from the outlet (38) of the first preparation module (2) to the intake of the second preparation module (2) by dragging the mixed sample fluid (37) into the second microfluidic preparation module (3) using a capillary effect of the channels of the second microfluidic preparation system (50),
performing the sample preparation specified by the second module (3), and
analysing the blood sample prepared by modular microfluidic sample preparation system (1) using the blood analysing apparatus.
